(19) United States
(12) Patent Application Publication
(10) Pub. No.: US 2006/0041921 A1
(43) Pub. Date: Feb. 23, 2006

(54) System and method for creating a virtual media channel

(76) Inventor: John K. Hane, Bethesda, MD (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 11/207,995

(22) Filed: Aug. 22, 2005

Related U.S. Application Data
(63) Continuation of application No. 09/660,185, filed on Sep. 12, 2000.
(60) Provisional application No. 60/164,334, filed on Nov. 9, 1999.
(60) Provisional application No. 60/202,079, filed on May 5, 2000.

(51) Int. Cl. H04N 7/10; H04N 5/445; H04N 7/173; H04N 7/16

(52) U.S. Cl. 725/117; 725/36; 725/46; 725/147

(57) ABSTRACT

A system and method for creating a virtual media channel including video, audio, multimedia, or other data, at or near the point of reception by end users remotely controls an operation of an end user receiving device. The present invention remotely controls an input source selection at the end user receiving device in a coordinated manner. These input sources may include terrestrial digital broadcast stations, direct broadcast satellites, other broadband data networks, data stored at the end user receiving device, internet content, multimedia files, and other programs or programming. By synchronizing the delivery of programs and programming from various sources and by remotely controlling the input source selection of the end user receiving device, the present invention provides for highly efficient integration of local and national broadcast signals, programs or programming available on other broadband networks, and programs and programming stored at the end user's receiving device. In particular, the present invention provides for the dynamic integration of programming originating from multiple sources, including integration of locally-originated programming with the programming of national program networks delivered by direct broadcast satellite providers or other satellite systems on a market-by-market basis. The present invention further provides for the direct addressing of individual end user receiving devices, allowing the creation of virtual channels of programming or other data that is unique to each end user or to certain classes of end users.

### CROSS-REFERENCE TO RELATED APPLICATIONS

This application is a continuation of U.S. patent application Ser. No. 09/660,185, filed Sep. 12, 2000, entitled SYSTEM AND METHOD FOR CREATING A VIRTUAL MEDIA CHANNEL, the entire content of which is hereby incorporated by reference, which claims priority to the following provisional applications which are incorporated herein by reference in their entirety: U.S. Provisional Application No. 60/164,334, entitled “SYSTEM AND METHOD FOR CREATING A VIRTUAL MEDIA CHANNEL,” filed Nov. 9, 1999 and U.S. Provisional Application No. 60/202,079, entitled “SYSTEM AND METHOD FOR CREATING A VIRTUAL MEDIA CHANNEL,” filed May 5, 2000.

### BACKGROUND

1. Field of the Invention

The present invention relates to integrating “national” and “local” broadcast material in a manner that makes highly efficient use of electromagnetic spectrum resources. More particularly, the present invention integrates the use of digital terrestrial broadcast facilities or other local facilities for the delivery of local programming to subscribers of national program networks distributed by direct broadcast satellite operators.

2. Discussion of the Related Art

Direct Broadcast Satellite (“DBS”) systems have been providing DBS services for several years. Available throughout the continental United States, DBS systems provide hundreds of channels of superior “digital quality” television to subscribers who purchase and install a relatively small satellite dish and a receiver that are typically available through various retail outlets and direct sales channels. The relatively small size of the satellite dish has allowed satellite television to make significant penetration into urban and suburban areas.

DBS systems have sufficient spectrum to provide hundreds of channels of digital quality video with which they offer virtually all of the program networks supplied by most cable television systems plus many others. Despite this large number of channel offerings, bandwidth limitations and other obstacles have prevented DBS systems from providing programming from all of their subscriber's local broadcast television stations. A signal from a single satellite associated with the DBS system may cover the entire continental United States (“CONUS”), so that every subscriber within CONUS generally receives the same programming at the same time. Because hundreds of “local” television stations operate within this coverage area, the simultaneous retransmission of all “local programming” requires far more spectrum than is available in the frequency bands currently allocated for DBS service.

Although some operators of DBS systems are currently designing satellites that provide the most popular local signals to the most densely populated areas, this approach may prove prohibitively expensive, given current technology, to provide high quality retransmission of all local televisions stations, including less popular stations in large markets and all stations in less densely populated areas. In any event, such a use of spectrum would be highly inefficient, because much of the programming of a local television station in one geographic area is identical to the programming of local television stations in other geographic areas. For example, virtually all of the NBC-affiliated television stations in the Eastern Time zone broadcast NBC network programming at the same time. Re-transmitting all of the local programming would involve simultaneously transmitting identical content over multiple channels resulting in the inefficient and redundant use of spectrum. Even the use of satellite “spot” beams, which focus satellite capacity on a smaller area, would result in the transmission of significant amounts of simultaneous, redundant programming.

Many national program networks (e.g., CNN™, Discovery Channel™, etc.) are formatted to allow for “insertion” of local programming, including local advertising and local news and weather updates. The local programming (also sometimes referred to herein as “local content”) enhances the television experience for the subscriber. Furthermore, the local programming provides substantial revenue opportunities for the television programming distributor, such as a cable television system, that may offer certain available advertising time periods (known as “local avails”) for sale to advertisers. Local cable television systems (i.e., cable operators), that process and supply their programming from “cable head-ends” that serve relatively small geographic areas, have greatly increased their capability to integrate local advertising and other local programming into these local avails. Cable operators accomplish this by inserting local content into appropriate local avails at the various local cable head-ends and sending the concatenated signals, or data stream, across their cable networks to subscribers. Cable operators that invest in the necessary equipment may insert local advertising and other local programming into the local avails of an unlimited number of channels. Because cable systems are, by their nature “local,” these cable operators are able to recover their investments by targeting their advertising and other programming to local markets.

Unfortunately, the bandwidth limitations in DBS systems have also prevented such systems from integrating such local programming into the national program networks. Although DBS systems have the ability to send the same programming to every point in the continental US, they lack sufficient ability to simultaneously send different programming to hundreds of different markets or geographic areas. Because their programming is sent directly from a DBS “uplink” facility—essentially a national head-end—any “insertions” into local avails will be sent simultaneously to many or all receivers across the CONUS. As a result, DBS systems currently cannot fill the local avails with programming that is “local” to each of the more than two hundred local television markets across the country.

Conventional broadcast television stations provide a single “channel” of programming over the air to anyone with a television and an antenna. The majority of the programming provided by broadcast television stations originates with an affiliated network and other syndicated sources, though many local stations produce a considerable amount of their own programming, including local news, advertising, and community service announcements. Broadcast television stations derive their revenue almost exclusively from advertising sales. The most profitable broadcast television stations maintain sophisticated local production capability and hold contracts with top on-air talent and program producers. These broadcast television stations have a unique capability to create local programming and integrate that programming into program streams delivered by national program networks such as NBC or CBS.

Like DBS systems, broadcast television coverage is essentially ubiquitous. Virtually all households in this country are within the coverage area of one or more television broadcast stations. Ironically, broadcast television stations suffer from the opposite spectrum limitation that afflicts DBS systems. A network of broadcast television stations covering the entire CONUS has great flexibility to transmit different programming simultaneously to various markets or cities. However, the same network of broadcast television stations has insufficient spectrum bandwidth to transmit simultaneously dozens of channels of television networks. In fact, the simultaneous transmission of identical network and other national programming by multiple local broadcast stations serving different geographic areas is a highly inefficient use of spectrum, since the network programming is not unique to each market and thus can be supplied with equal effectiveness by satellite.

Broadcast television stations are now in the process of upgrading to digital television (DTV) facilities that will provide the capability to offer four or more simultaneous program channels (i.e., program streams). While an improvement over single channel analog systems, this number of channels is still insufficient to allow broadcast television stations to compete for subscribers in a market dominated by cable and DBS services that provide ten or even one hundred times as many channels.

Neither the DBS system nor the local broadcast television stations with DTV facilities efficiently provides the varied national programming with targeted local programming required by today's subscribers and station operators. Thus, what is needed is a system and method for creating a virtual media channel that overcomes these and other problems associated with conventional systems.

### SUMMARY OF THE INVENTION

The present invention provides a system and method for significantly increasing the efficient use of spectrum for broadcast purposes, by reducing the transmission of redundant programming and other information, while providing for the transmission of local programming to particular geographic areas or markets. The present invention also provides an integral system for accepting, scheduling, delivering, and verifying delivery of advertising and other programming. As noted above, DBS systems efficiently provide national programming while DTV systems efficiently provide local programming. As used herein, national programming shall refer to programming not specific to any particular geographic area, while local programming shall refer to programming targeted or relevant to a particular geographic area or market. The present invention capitalizes on these presently unrealized efficiencies by coordinating one or more local programming streams provided by one or more local broadcast television stations having DTV facilities with one or more national programming streams distributed by one or more DBS systems so that the national programs appear to be supplemented with local content. Thus, subscribers in different markets view their own local version of a national program. In other words, a first subscriber in Kansas City views CNN supplemented with local news and advertising breaks pertinent to the Kansas City area, while a second subscriber in Chicago views CNN supplemented with local news and advertising breaks pertinent to the Chicago area.

Rather than inserting local programming into the CNN network program stream and subsequently transmitting the concatenated package to the subscriber via the DBS system, and rather than transmitting the entire CNN network program stream from each local broadcast television station, the present invention remotely controls a receiving device located at the subscriber's point of reception. The remote control operation switches the receiving device back and forth between programming streams emanating from a common source or one or more sources (e.g., between a national programming source and a local programming source, or alternately between various national programming sources). The local programming may be synchronized to fit within appropriate breaks in the national programming, but may be delivered from an entirely independent source, either in “real time” or in advance and cached in the subscriber's receiving device. This minimizes the use of scarce spectrum resources for the retransmission of redundant information while providing for the tailoring of national programming toward a particular geographic area or local market. Moreover, because most national programming is formatted for only a few minutes of local breaks in each hour, and because the timing of those local breaks varies from network to network, a single local broadcast station can be leveraged to provide local programming for several national programming networks. Thus, two or more local DTV channels would provide sufficient capability to provide local content to dozens of national networks.

One feature of the present invention is to overcome major competitive disadvantages faced by both DBS systems and local broadcast television systems that result from capacity limitations inherent in the amount of spectrum allocated to each respective service and licensed to each respective operator.

Another feature of the present invention provides for a “virtual media channel” in many other contexts through the coordination of programming emanating from one or more sources, either in real time or via caching on the subscriber's receiving device, and remote control of the subscriber's receiving device for dynamic selection of the channel or other source.

Another feature of the present invention causes the automatic transmission of certain data and program material, pursuant to switch commands, in accordance with certain delivery commitments; accepts and distributes delivery commitments and the associated program content; prioritizes the execution of delivery commitments to ensure the most valuable or time sensitive commitments are executed before less valuable or more latency tolerant commitments are executed; verifies whether switch commands have been executed by a subscriber receiving device; and re-transmits certain data or program material until said delivery commitments have been met and verified. According to a preferred embodiment, priorities can be assigned to the delivery of data and program material and in some cases, the subscriber's desires may have top priority.

Another feature of the present invention causes the switching, at the subscriber's receiving device, between programming or data streams from one or more sources to an alternate programming or data stream from the same source (i.e., between channels emanating from the same source) or from another source (i.e., between national programming and local programming or between national programming and programming pre-cached in the subscriber's receiving device).

Yet another feature of the present invention allows the virtual integration of the programming or data stream of one or more DBS systems with the programming or data stream of one or more local DTV systems to provide a full service television offering that includes both local DTV signals and virtual “localized” versions of national program networks transmitted by DBS systems. A virtual localized channel, for instance, would be comprised of a live, national feed of CNN (delivered by a DBS service) supplemented, at appropriate breaks in CNN programming, with local news updates and local advertisements (delivered by a local television station) that are unique to each television market.

Still another feature of the present invention is that the receiving device receives programming from DTV systems and integrates it with programming from DBS systems. In this manner, the present invention provides subscribers of DBS systems with local programming to which they might otherwise have limited access. Thus, the present invention allows subscribers to receive both local broadcast stations and virtual “localized” versions of many other national networks.

Still another feature of the present invention creates a new platform for the delivery, and verification thereof, of large amounts of digital information wirelessly across large broadband networks according to user-defined parameters. The invention gives individuals and enterprises on-demand access to a wide area broadcast network for real time or delayed delivery of vast amounts of digital information, and allows individuals to control their media centers and other devices remotely, all from the simplicity of a web-based interface.

Another feature of the present invention provides that DBS systems working together with local broadcast television stations may capture the economic value of local available time slots with which many DBS-delivered networks are formatted.

Yet another feature of the present invention provides for the fully automated sale and delivery of local advertising. Because of the relatively low penetration of DBS services in the U.S. market (roughly ten percent of all households) and the highly fragmented viewing patterns that characterize multi-channel programming, the number of people watching a particular national programming network (e.g., the USA Network™, CNN, Discovery Channel) on any particular DBS system and in any particular city at any particular time is likely to be quite low. The value of an advertisement (or other programming or data) delivered to so few viewers may be quite small, such that the transactional costs of selling and delivering the advertisement in a conventional manner might exceed its value. Moreover, the difficulty of measuring audiences so small and so fragmented with traditional tools further devalues these local avails. Traditional advertising sales methods, in which salaried or commissioned salespeople negotiate one-on-one with professional media buyers, are far too cumbersome and costly for the profitable sale of such low-yield inventory. The present invention, by reducing the incremental costs of selling, completing, and measuring the delivery of advertising and other programming and data to virtually nothing, makes this fragmented market for advertising and other data attractive.

Another feature of the present invention provides an electronic exchange for the purchase, sale, and/or trading of advertising or other electronic delivery obligations. The present invention, as disclosed herein, allows authorized users to access the present invention to post for sale advertising avails or other inventory that permits the delivery of programming or other data, and allows authorized users to bid for and to purchase certain delivery commitments. In many cases such users may bid for delivery commitment rights with the intention of having a particular advertisement or other data delivered in the near term according to certain parameters. In other cases, such users may anticipate an increasing demand for advertising inventory, and may bid for and purchase delivery commitments (according to standard delivery parameters or according to user-defined parameters) far into the future, either in order to ensure access to sufficient advertising inventory at favorable prices, or for speculative purposes. Having purchased such delivery commitment rights, such users may exercise such rights by using the advertising inventory, or they may offer to sell that inventory (as represented by the delivery commitment rights) to prospective buyers through the present invention. Similarly, vendors of advertising (such as television and radio stations, cable television systems, web sites, and print media) may post some or all of their inventory for sale through the present invention. The present invention thus creates an electronic platform for the highly efficient purchase, sale, and exchange of advertising and other delivery commitments, with automatic execution and proof of performance of such delivery commitments.

Other features and advantages of the invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a communications environment within which a virtual channel programming and delivery system operates according to one embodiment of the present invention.

FIG. 2 is a flowchart that describes a method for creating a virtual media channel according to one embodiment of the present invention.

FIG. 3 is a flowchart that describes the scheduling of delivery requests in greater detail according to an example embodiment of the present invention.

FIG. 4 is a flowchart that describes delivering programming or other data specified by the delivery request in greater detail according to an example embodiment of the present invention.

### DETAILED DESCRIPTION

The present invention is a system and method for creating a virtual media channel. The present invention generates one or more commands based on user input and/or system feedback, distributes the commands across one or more telecommunications networks to various devices capable of executing the commands, and optionally collects and compiles information regarding whether and how each device responded to the commands. According to one embodiment, the present invention may also deliver data, including multimedia data, in synchronization with the delivery of the commands. In a preferred embodiment, the present invention remotely issues switch commands that have the effect of changing, in synchronization with certain programming or data streams intended to be received by such devices, an input source or channel selection of a receiving device at plurality of locations.

Overview

The present invention will now be described with respect to a preferred embodiment of the integration of DBS systems and DTV systems to deliver video and multimedia programming including local content and, in particular, local advertising. As will become apparent, the present invention has many applications that are unrelated to this preferred embodiment. For example, various embodiments of the present invention may be used to schedule and deliver large amounts of digital data via an otherwise unused portion of a communication channel, e.g., a local broadcast television system.

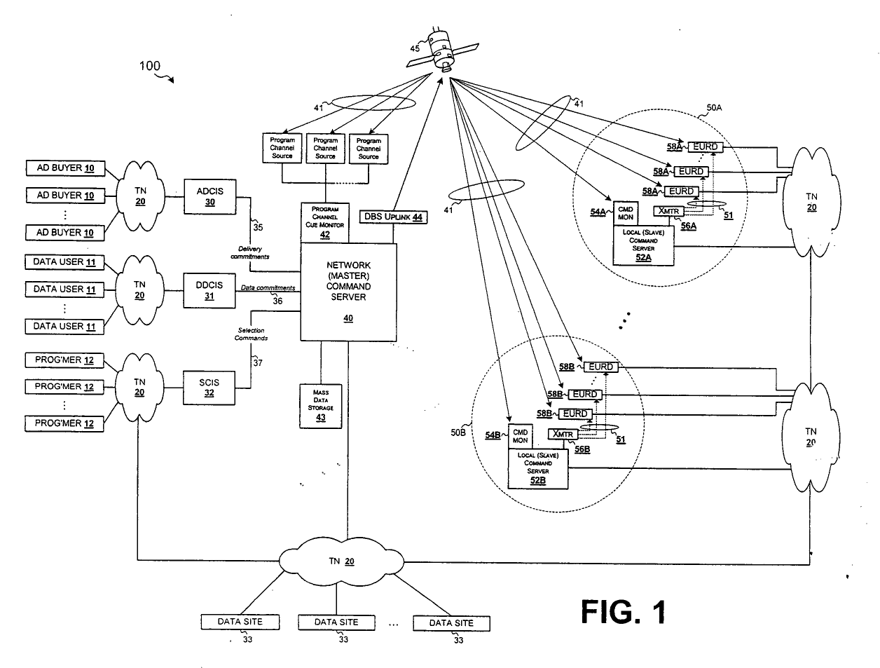

FIG. 1 depicts a communications environment 100 within which example embodiments of the present invention operate. A DBS satellite 45 broadcasts a plurality of program channels 41 to a network command server 40, a plurality of local command servers 52 (shown as 52A and 52B), and to a plurality of receiving devices 58 (also referred to herein as end-user receiving devices or “EURD”, and shown as 58A and 58B). According to one embodiment of the present invention, program channels 41 can represent, for example, any of the program networks supplied by most cable systems plus many others as well as pay-per-view movies and other programming requiring additional fees. Program channels 41 can, in general, represent any broadcast digital signal such as digital data.

Network command server 40 communicates with DBS satellite 45 via a DBS uplink 44. DBS satellite 45 can also relay signals from network command server 40 to local command servers 52 and receiving devices 58. Network command server 40 can include a program channel cue monitor 42 that monitors program channels 41. When program channel cue monitor 42 identifies an upcoming local program segment, it forwards cue data (including time of the tone and the identity of program channel 41) to network command server 40 (described in greater detail below). Network command server 40 can also include a mass data storage 43 representing, for example, one or more databases or lookup tables storing information regarding available inventory, viewership data, and the tone timing and patterns of each program channel 41.

Further, network command server 40, local command servers 52, and receiving devices 58 can also communicate via a telecommunications network 20. Telecommunications network 20 can represent, for example, a digital network (e.g., the Internet, a wide-area network, a local area network), a public switched telephone network (PSTN), a terrestrial or satellite wireless network, or any combination of the aforementioned networks.

As depicted in FIG. 1, local command servers 52 and receiving devices 58 can be divided into a plurality of geographic areas 50 (shown as 50A and 50B), where one or more local command servers 52 service a plurality of receiving devices 58. One or more terrestrial broadcast DTV stations (shown as XMTR 56A and 56B) are associated with each local command server 52. DTV stations 56 broadcast one or more DTV channels 51 that can be received by those receiving devices 58 within the service area 50. Programming or data files delivered through the present invention to receiving devices 58 may or may not be designated for broadcast to the general public.

Receiving devices 58 can be implemented as a device enabled with the technology of the present invention housed in a unit separate from the television or other viewing device, or alternatively, can be integrated within the viewing device itself. The separate unit devices can, for example, be installed as a “set-top box” which sits on or in proximity to the viewing device, or alternatively, can be installed outside the user's premises on an outer wall or rooftop, such as in proximity to a DBS satellite dish and receiver. Receiving devices 58 respond to commands received from external sources (such as local command server 52 and/or network command server 40) via program channels 41, DTV signals 51, and/or telecommunications network 20. Commands can cause, for example, receiving device 58 to perform a wide variety of operations, including switching between various program sources (such as program channels 41 received from DBS satellite 45 and DTV channels 51 received from DTV stations 56) at specific points in time, thereby allowing the real-time integration of multiple program sources in a way that is seamless to the consumer or other end user.

For example, a command embedded in a Discovery Channel program feed delivered to a satellite television subscriber may cause the subscriber's set-top box to “change channels” precisely at the beginning of a local advertising break and instantly display a specific local advertisement that is coordinated for broadcast by a local television station at that moment, with another command causing the subscriber's set-top box to “re-tune” to the Discovery Channel immediately after the local advertising break ends. Thus, “local” and “network” program streams can be integrated in real time, at the point of reception by the end user, so that the user's viewing experience is functionally identical to that of a subscriber to a cable television system that inserts local content into appropriate breaks in network programming at the “head-end” facility.

Other commands that can be coordinated and delivered using the technology of the present invention include (but are not limited to) the conditional storage of certain data at the end user, the display or other processing of data stored at the end user, adjusting display or audio properties, accessing and retrieving programming or data stored off site, presenting the end user with a menu of options and conditionally executing contingent commands based upon user input, or executing a more complex computer program (such as a Java script).

According to an example embodiment of the present invention, receiving devices 58 are also capable of receiving and processing multimedia data, including video signals, from multiple input sources, each of which may deliver multiple channels of video or data. Receiving devices 58 are also capable of executing commands received from one or more of these inputs sources or from independent input sources, which commands, upon execution, are capable of changing or modifying the output of receiving device 58. Such commands include, but are not limited to, those that cause receiving device 58 to switch from one input source to another, or among multiple channels regardless of input source. Receiving device 58 may optionally store certain data, including records of all commands that have been received and/or executed within a predetermined time period, and may forward such stored data to a server accessible via telecommunications network 20, such as network command server 40, that is capable of influencing the issuance of additional commands based on the data it receives from one or more receiving devices 58.

### EXAMPLE USERS OF THE PRESENT INVENTION

Various classes of users may gain access to the remote command and delivery capabilities of the present invention. As shown in FIG. 1, communications environment 100 depicts three example classes of users: media buyers 10 (shown as AD BUYER), data users 11, and programmers 12. These different types of users can access the system of the present invention via different input sources tailored to their particular needs, and might request delivery of different types of data depending upon their objectives, and depending upon available inventory. These delivery requests commonly involve the delivery of some digital data, whether digital programming, data, or control, to one or more delivery devices 58. End users may also access the remote command and delivery capabilities of the present invention. End users can access the system via input sources similar to those described above in order to control their own receiving devices via commands delivered by the present invention.

For example, media buyers 10 represent those entities interested in purchasing various types of inventory available through network command server 40, such as local avails in one or more areas 50. In one common situation, media buyer 10 may wish to arrange for the delivery of a television advertisement to a certain audience. These delivery requests are referred to herein as delivery commitments 35, representing requests to the network to deliver advertisements to specified markets. Media buyers 10 access the system of the present invention through an advertising delivery commitment input source (ADCIS) 30, such as a web site, that can accept delivery commitments 35 from media buyers. Information related to the inventory purchased by media buyers 10 can be stored in one or more data sites 33 accessible via telecommunications network 20. For example, media buyer 10 can purchase a local avail to run an advertisement that is stored at data site 33. Network command server 40 can access (or direct another device to access) the advertisement as necessary to ensure that the advertisement is transmitted at the appropriate time and location.

As a second example, data users 11 represent those entities interested, for example, in accessing the present invention to cause the delivery of certain data to one or more receiving devices 58. For example, a high-resolution image vendor needing to refresh large databases at multiple receive sites may wish to access the present invention to cause the data to be delivered within the data stream of digital television stations. Similarly, a corporate MIS administrator needing to update a very large database of proprietary data simultaneously at a large number of widely dispersed locations may secure a commitment for the delivery of the update data through the same infrastructure. These data requests are referred to herein as data commitments 36, representing requests to the network to deliver user data to one or more receiving devices 58. Such data may or may not be intended for reception by the general public, and if not, can be encrypted or transmitted in a format that would not normally be useful to the general public. Data buyers 11 access the system of the present invention through a data delivery commitment input source (DDCIS) 31, such as a web site, that can accept data commitments 36 from data users 11.

As a third example, programmers 12 represent those entities interested, for example, in using the present invention to schedule and cause the delivery of non-advertising matter, generally referred to as “program content” or “programming”, to one or more receiving devices 58. Such program content might comprise a local news update intended for delivery to viewers of a certain national program network during a particular break in that network's programming. As another example, an enterprise may desire to book a small amount of bandwidth at a specific time in a variety of urban areas for broadcast streaming delivery of a press conference. These delivery requests are referred to herein as selection commands 37, representing requests to the network to deliver user programming to one or more receiving devices 58. Programmers 12 access the system of the present invention through a selection command input source (SCIS) 32, such as a web site, that can accept selection commands 37 from programmers 12.

Other classes of users, not specifically depicted in FIG. 1, are also contemplated by the present invention who gain access to the present invention using an appropriate input source, such as a web site tailored for certain kinds of input. For example, a virtual marketplace can be provided where buyers and sellers transact in inventory controlled by network command server 40. A DBS operator holding rights to the local avails in a plurality of program networks may post that inventory for sale. A local television station with excess data capacity in its DTV data stream during given periods of time may post that inventory for sale. As another example, an individual away from home may wish to command his receiving device to record a particular program or file for later playback or retrieval. Here, the delivery request represents a request to the network to deliver digital command signals to one or more receiving devices 58.

Operation

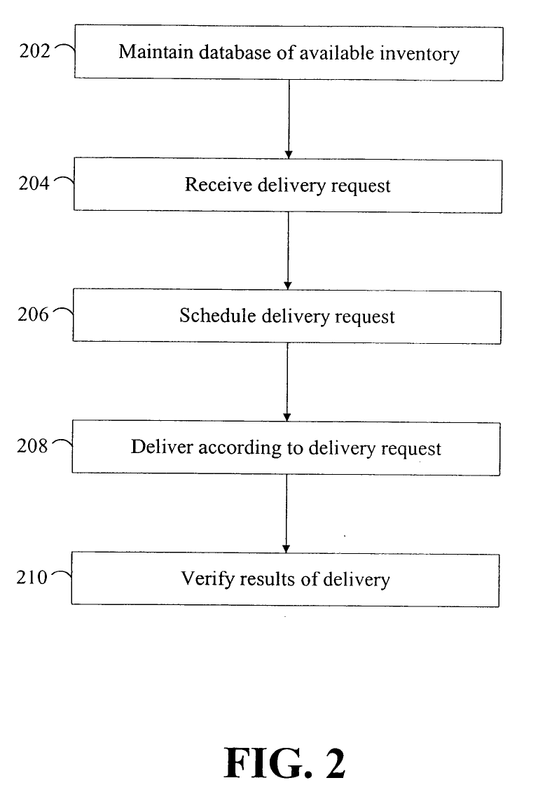

FIG. 2 is a flowchart that describes a method for creating a virtual media channel according to a preferred embodiment of the present invention. For purposes of illustration, the operations depicted in FIG. 2 will be described with respect to an example media buyer 10 submitting a delivery commitment 35 to network command server 40. However, it will become clear to those skilled in the art that the example operations described with respect to media buyers 10 will also apply to other classes of users. With respect to media buyers 10, the present invention includes (1) maintaining a database of available inventory against which delivery commitments may be sold; (2) receiving delivery commitments for certain programming or multimedia data within available inventory; (3) scheduling programming or other data for delivery according to specific conditions or requirements; (4) delivering that programming or other data in accordance with the specific requirements; (5) verifying that the programming or other data has been delivered; and (6) scheduling additional deliveries of the programming or data as necessary until the specified delivery commitment has been achieved.

These operations are described in greater detail below.

Maintaining a Database of Available Inventory

In operation 202, a database is maintained that stores inventory available for the satisfaction of delivery commitments with the available inventory classified according to its features. In the case of television advertising, inventory features would include such factors as avail length, date, time, program channel, program segment (e.g., local newscast, specific movie, specific sitcom), geographic area (e.g., national, Dallas, mid-west), audience size and demographic profile, and the like, as well as the identity of the owner of the inventory and any conditions of sale (e.g., minimum price). Inventory may be general and perpetual (e.g., all local avails in CNN Headline News nationwide) or very specific (e.g. one avail in the local Miami broadcast of the Super Bowl). Inventory may be posted by owners or their agents through an appropriate input source, which in a preferred embodiment may include a web-based interface with appropriate access restrictions and authentication procedures. Because inventory may be freely bought and sold either through the system of the present invention or through other mechanisms, inventory may be owned and therefore posted by persons who have no direct responsibility for fulfillment.

Receiving Delivery Requests

In operation 204, a delivery request is received from a user. In the media buyer 10 example, the delivery request is represented by a delivery commitment 35. As one aspect of the present invention is to automatically deliver advertising, video programming, multimedia content, or other data according to criteria established by the user, the present invention permits a plurality of users to specify delivery requests. In other words, users with appropriate authorization may access the present invention and cause it to make certain deliveries by submitting a delivery request.

For example, media buyer 10 may wish to schedule the broadcast delivery of a television advertisement; specifically, the media buyer requires 1,000,000 impressions of a thirty second advertisement for Citibank™ delivered to adults between the ages of 25 and 54, with the audience restricted to viewers in Boston, New York, and Washington D.C. (One “impression” is defined as one delivery of a single advertisement to one household.) An advertising campaign may typically have other conditions, such as requirements that all of the advertising be delivered between November 15 and November 22, for example, and that no advertisements be placed on a particular network, (e.g., MTV).

Media buyer 10 accesses the system of the present invention through ADCIS 30. The prospective buyer may browse the inventory database to determine what inventory may be available for purchase. In addition, ADCIS 30 includes fields or other mechanisms for allowing the media buyer to enter the necessary parameters (e,g., time frame, markets, length of advertisement, preemptability). According to the specific implementation of the invention, the buyer may specify as purchase parameters any or all of the parameters under which the inventory may be classified, providing greater flexibility than conventional systems.

For example, in a conventional system media buyers 10 generally determine how many different individuals of a particular demographic should see a given advertisement (this variable is referred to as “reach”) and how many times they should see the advertisement (this variable is referred to as “frequency”). They then consult historical viewership data for various television programs and choose which specific advertisement timeslot they must purchase in order to achieve the desired reach and frequency. The present invention would allow media buyers 10, for example, either to specify the specific advertisement timeslot in the specific programs that they desire to purchase, or, alternatively, to specify the needed reach and frequency (along with any restrictive parameters, such as excluded program channels, time limits, etc) and allow the present invention to achieve that reach and frequency in the most efficient manner. The present invention thus allows buyers to purchase advertising either on a commodity basis or per unit.

Upon receiving a delivery request, the present invention first determines whether both the technical capability and the available inventory will satisfy the requested delivery. If all or part of the delivery can be satisfied, the present invention calculates and returns a price for the order and may state other conditions of acceptance. The present invention may be programmed to determine the price according to various criteria, including empirical data from prior sales, supply and demand, preclusive and preemptive effect on other pending delivery commitments, scheduling flexibility, competing bids from other prospective purchasers, and other factors. If the buyer accepts the price and conditions, the buyer may specify the location of one or more digital file(s), such as files stored in one or more data sites 33, that include the advertisement to be delivered. Alternatively, the buyer may deliver the advertisement via a conventional method as would be apparent. In either case, the buyer may subsequently receive a confirmation that the advertisement was received.

Scheduling

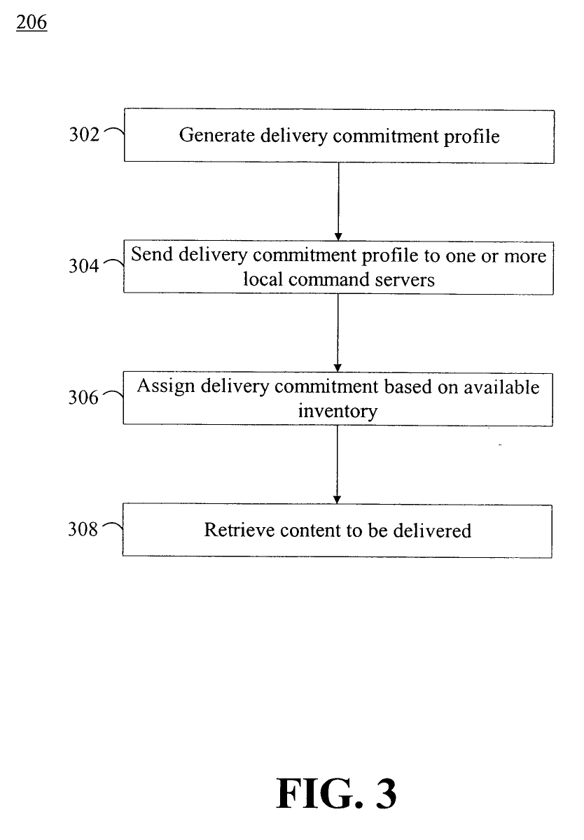

In operation 206, after negotiating the transaction with the buyer, the accepted delivery request is scheduled for delivery. FIG. 3 is a flowchart that describes operation 206 in greater detail according to an example embodiment of the present invention. In operation 302, a delivery commitment profile is generated according to the received delivery request and sent to network command server 40. Network command server 40 enters the delivery commitment profile into database 43. The delivery commitment profile preferably identifies (i) the intended recipients (e.g., women between 18 and 34); (ii) the size of the delivery (e.g., 1,000,000 impressions); (iii) time limitations (e.g., 5 days) and (iv) content (e.g., URL of the file comprising the spot(s) to be broadcast). Other parameters may also be specified, including for example, level of execution priority and/or preemptability and make-good rights.

In operation 304, the delivery commitment profile generated in operation 302 is distributed to those local command servers 52 in the areas specified by the delivery request. For example, the profile might be sent to local command servers 52 associated with digital terrestrial television stations located, for example, in Boston, New York, and Washington, thereby assigning a portion of the delivery obligation represented by the delivery commitment to those stations. The delivery commitment profile may be delivered via DBS uplink 44 and DBS satellite 45 or via telecommunications network 20.

In operation 306, local command server 52 assigns the delivery commitment based on available inventory. According to an example embodiment of the present invention, each local command server 52 posts the delivery commitment profile to its local database of commitments and matches the delivery commitments to available inventory and makes tentative assignments (adjusting prior assignments to the extent necessary and according to defined parameters).

In operation 308, a copy of the programming or other data to be delivered (e.g., an advertisement according to the above example) is retrieved from a remote server (e.g., data site 33). According to an example embodiment of the present invention, local command server 52 retrieves the programming or other data and stores that content for later broadcast. Alternatively, local command server 52, if coupled with a robust telecommunications network connection to the remote server, may retrieve the file comprising the content to be delivered on demand, thus retrieving and transmitting the content on-demand and in “real time”.

Delivery

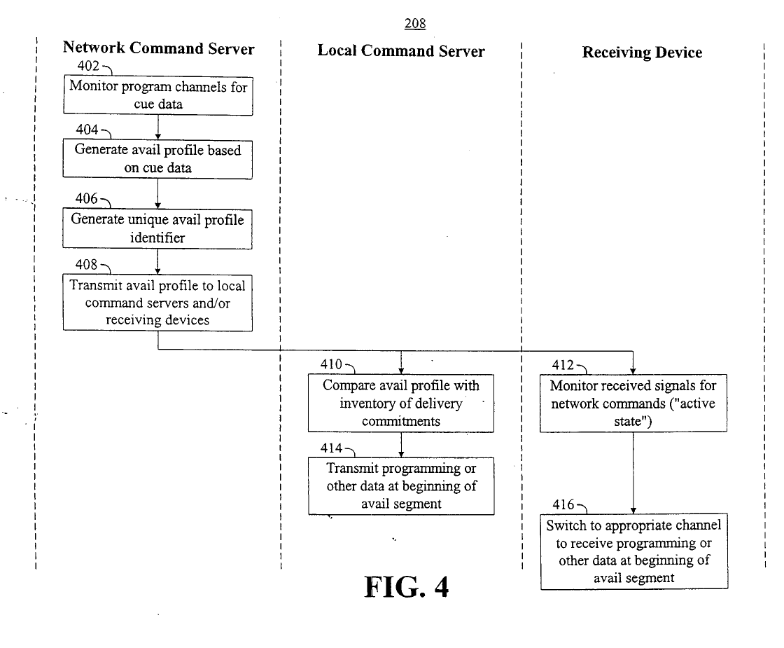

Returning now to FIG. 2, in operation 208 programming or other data is delivered according to the delivery request. FIG. 4 is a flowchart that describes operation 208 in greater detail according to an example embodiment of the present invention. The operations depicted in FIG. 4 are separated in the horizontal dimension according to where the operation is performed, i.e., network command server 40, local command server 52, or receiving device 58. In operation 402, program channels 41 are monitored for cue data indicating that an avail segment is upcoming. Program channels that are formatted for the inclusion of local program segments generally precede local segments with one or a series of “cue tones” or other electronic tags that provide advance notice of the exact timing of local segments. According to the example embodiment depicted in FIG. 1, network command server 40 is equipped with a program channel cue monitor 42 which continuously monitors a plurality of program channels 41 transmitted by DBS satellite 45. Program channel cue monitor 42 forwards to network command server 40 the cue data once an upcoming local program segment is identified, where the cue data includes the time of the tone and the identity of the program channel.

In operation 404, an avail profile is generated based on the cue data. According to an example embodiment of the present invention, network command server 40 applies the cue data to its lookup tables and generates an avail profile that may identify (a) the applicable program channel 41; (b) the exact time of the local program segment; (c) the length of the local program segment; and (d) the viewership profile of the local program segment. Thus, an avail profile may include, for example, the following information: Channel: Cable News Network/Length:30/Age 18-24: 98,000F 94,000M/Age 25-54: 226,000F 244,000M/Age 55+: 124,000W 112,000M/Start time: 20:57:53.33/.

Network command server 40 maintains one or more databases or lookup tables in mass storage 43, including information regarding (i) inventory that is available for satisfaction of delivery commitments, including if appropriate, the number and length of scheduled local program segments for each hour of each day on each monitored program channel 41; (ii) known or estimated viewership data for each monitored program channel 41; and (iii) the tone timing and patterns of each monitored program channel. Viewership data may include all known and/or predicted information regarding the viewership of the program channel at the relevant time, including demographic, psychographic, and geographic information about viewers. These databases, or a subset of these databases, may be replicated at each local command server 52. In addition, the databases maintained by the local command servers may be modified, enhanced, or supplemented with additional or different data that is unique to that server. For example, the viewership data of CNN may vary between Chicago and Tallahassee.

In operation 406, network command server 40 generates a unique avail profile identifier, which is transmitted as part of the avail profile. The avail profile may be generated as a digital data packet or as an analog sequence as would be apparent. Alternatively, network command server 40 may forward the cue data to the local command server, which may generate unique avail profiles that reflect the more specific information maintained in those respective databases.

In operation 408, network command server 40 transmits the avail profile to all local command servers 52 in the network, each of which may be associated with one or more host DTV stations, as well as preferably to all receiving devices 58. The transmission of the avail profile to either local command servers 52 or receiving devices 58, or to both, may travel via DBS uplink 44 and DBS satellite 45, or via telecommunications network 20. Alternatively, receiving devices 58 may receive the avail profile from the appropriate local command server 52.

Receiving devices 58 and local command servers 52 respond to reception of the avail profile differently. A local command server may respond to the command by causing its host DTV station to transmit programming (as disclosed in more detail below), and the receiving device may respond by receiving and displaying the programming transmitted by the host DTV station.

In operation 410, upon receipt of the same avail profile each local command server 52 immediately compares the avail profile to its database of pending delivery commitments. If local command server 52 has previously assigned a program segment or data file to that avail, then local command 52 server causes the delivery of that program segment or data. If no program segment or data file has been assigned to that avail, as described in more detail below, the local command server determines whether the avail segment identified in the avail profile can be used to satisfy one or more pending delivery commitments in whole or in part. If so, in operation 414, local command server 52 causes the transmission of the programming or other data to begin at the precise moment necessary to correspond to the beginning of the avail segment. The local command server may optionally precede the transmission of the programming or data with specific network commands, including instructions regarding the reception of the data or programming (for example, addressing the data or programming to sets or subsets of receiving device 58) and/or processing of the data or programming (for example, whether the data or programming is to be stored within the receiving device 58 memory for later use or display (upon a command of the local command server or, optionally, the user), displayed in “real time”, run as an executable file such as a Javascript, processed in connection with other programming or data, and whether a report of the command's execution by the receiving device 58 should generated and transmitted back to network command server 40 and the host local command server 52).

In operation 412, the avail profile causes each receiving device 58 to set to an “alert” state in which it actively monitors the broadcast signal propagated by the host DTV station for a network command that may instruct the receiving device to perform one or more functions. In operation 416, receiving device 58 switches channels to receive the local DTV broadcast signal 51 in response to receiving the appropriate network command.

Following the above-mentioned Citibank example, local command servers 52 associated with DTV stations in Boston, New York, and Washington, receive the avail profile from network command server 40. Upon receiving the avail profile for the CNN avail, the local command servers compare the avail profile to delivery commitments stored in their respective databases. Each local command server identifies a subset of pending delivery commitments that could be satisfied in whole or in part through the time slot identified in the avail profile. In most cases, the local command server can determine minutes, hours, or even days in advance which delivery commitment to apply to individual avail segments. With the exception of certain “live” programming, the approximate number and timing of avail segments within each program network is known well in advance. In such cases, the system of the present invention will often be capable of delivering programming, data, or commands to the subscriber's receiving device in advance and storing that data therewith.

The delivery commitment subset identified by the local command servers hosted by DTV stations in Boston, New York, and Washington will include at least the Citibank advertisement, because the parameters of the CNN avail profile substantially match the parameters of the Citibank delivery commitment. The matching subset of pending delivery commitments at each host DTV station will likely include other candidate delivery commitments. From the subset of matching delivery commitments, each local command server will immediately determine (1) whether the CNN avail should be captured, and (2) if so, which delivery commitment to apply to the CNN avail. Every local command server includes memory in which it stores a full history of all avail profiles received and of all network commands and program segments transmitted in response to the avail profiles. The local command servers use this data, along with data received from receiving device 58 and from network command server 40, to determine when pending delivery commitments have been satisfied.

In the present example, the local command servers in Washington and Boston may determine to capture the CNN avail and apply the Citibank advertisement, while the New York local command server may have a higher priority delivery commitment that matches the CNN avail profile, and thus may select a different advertisement to apply. A higher priority delivery commitment might be one for which an advertiser has paid a higher price, an unfulfilled delivery commitment with an earlier completion requirement, a breaking local news story or a matter of public urgency (such as a tornado warning), or some other programming or data that represents a higher and better use of the CNN avail by any local command server.

In the instant example, the local command servers in Boston and Washington, having calculated that delivery of the Citibank advertisement constitutes the highest and best use of the CNN avail, command their associated digital servers to access the Citibank advertisement digital file from its data storage/memory, decode it, and send it to the host DTV station's multiplexer, which incorporates the Citibank advertisement into the host DTV station's transmission stream. Transmission of the Citibank advertisement is preceded by a network command that instructs the receiving device 58 to receive, decode, and display the Citibank advertisement, as well any optional requirements.

Receiving devices 58 (set to an alert state in response to the same avail profile that triggered the Citibank advertisement) tuned to CNN in Boston, New York, and Washington receive the advertisement. Upon receiving the network commands, receiving devices 58 receive, decode, and display the advertisement, followed by a return to reception, decoding, and display of the CNN program stream in synchronization with the end of the avail segment. Alternatively, the avail profile may cause the subscriber's receiving device to display appropriate programming or process data that has been previously delivered to and stored by receiving device 58.

The local command servers may also issue commands that are not associated with programming originating from the host DTV station. For example, the local command server may simply command a subset of receiving devices 58 to change from display of one DBS program stream to another, to present the end user with a menu of choices, to record certain programming or data on the receiving device's storage, or to take other actions as would be apparent.

Verification and Feedback

Returning again to FIG. 2, in operation 210 the results of the delivery accomplished in operation 208 are verified. In a preferred embodiment, each receiving device 58 includes memory (not shown) for recording its history of command execution and is linked through a transmission path (e.g., telecommunications network 20) to network command server 40 and, either directly or indirectly via network command server 40, to its host local command server 52. Each receiving device 58 may record all avail profiles and network commands it receives and a full history of the device's response to each event, and forwards such data to network command server 40 and to local command server 52 via telecommunications network 20. The history includes key data regarding the device, including the identity of the host DTV station that issued each network command and the location of the device.

Network command server 40 compiles key data derived from the histories generated by the plurality of local command servers 52 and the plurality of receiving device 58 and makes appropriate modifications to its database of pending delivery commitments. In the present example, the CNN avail may have resulted in 52,000 impressions of the Citibank advertisement in Boston and another 49,000 matching impressions in Washington D.C. Because this degree of fulfillment may affect the priority each local command server applies to the Citibank advertisement for future avail segments, network command server 40 forwards all relevant data regarding delivery fulfillment to all local command servers 52 in the affected markets of Washington, D.C., New York, and Boston. This system of ongoing feedback ensures that delivery commitments can be achieved using programming and delivery systems that are characterized by low concentrations of viewership.

Although a preferred embodiment of the present invention may utilize the DTV and DBS infrastructures to deliver video and multimedia programming to end users, the present invention will have many other uses that will be apparent to those skilled in the art. The present invention contemplates a plurality of input sources for receiving input inventory and delivery commitment through which various classes of users may gain access to the control and delivery capabilities of the present invention. According to example embodiments of the present invention, input sources can be optimized for input of inventory and delivery commitments regarding:

(1) television advertising (or other video, audio, graphical, or multimedia advertising) intended for public reception; Operators of television and radio stations, web sites, DBS services, cable television systems, and other electronic media outlets may wish to access the system of the present invention to post for sale some or all of their available inventory. Others, including consolidators or speculators who have purchased such inventory may also wish to post it for resale. Similarly, electronic advertising buyers, particularly television, radio, and web site advertising buyers, may wish to use the system of the present invention to purchase and arrange for the delivery of advertising according to certain criteria, as described more fully below. A preferred embodiment of inventory and delivery commitment input sources for television advertising, for example, would be based on a user/computer interface accessible through a publicly accessible computer network (such as the Internet) or a private, remotely accessible computer network (such as a local area network, a wide area network, an intranet or an extranet). A delivery commitment input source optimized for this purpose would allow the user—seller or buyer—to specify a range of parameters relating to the inventory or needed delivery, as appropriate. Because individual users could be empowered to cause the broadcast or other transmission of programming into a plurality of homes and other receive sites, possibly without further review, access may be strictly limited to approved users, each of which may be further restricted. Once the present invention negotiates and accepts such delivery commitments, in many cases it may then generate switch or other commands that would be delivered in conjunction with the actual data that includes the advertisement. The switch commands thus generated facilitate the actual delivery of the advertising to the intended recipients;

(2) other non-advertising video, audio, graphical, or multimedia programming; Persons responsible for programming various television or other electronic media networks or program channels may wish to use the present invention to schedule and cause the delivery of non-advertising matter, generally referred to as “program content” or “programming”. Such program content might comprise a local news update intended for delivery to viewers of a certain national program network during a particular break in that network's programming. Alternatively, a programmer might desire to cause the delivery of an entire program, such as a thirty minute political advertisement, “free and in the clear” to anyone with capable receiving equipment, at a certain time. Alternatively, a programmer of multiple, simultaneous program streams may wish to cause a receiving device to switch dynamically among the various program streams. A preferred embodiment of a delivery commitment input source for such types of programming may be characterized by highly restricted access; for example, by requiring direct input (via a computer/user interface) at restricted locations rather than via open networks. Thus, a programmer at a local digital television station might have exclusive rights to cause the delivery of non-advertising programming that is intended for reception by the general public. As in the case of advertising delivery commitments, the present invention may generate switch or other commands to be delivered in conjunction with the actual data that constitutes the advertisement. The switch commands so generated facilitate the actual delivery of the programming to the intended recipients;

(3) other data and applets; Certain users may wish to access the present invention to cause the delivery of certain non-broadcast data via certain transmission networks. For example, a high-resolution image vendor needing to refresh large databases at multiple receive sites may wish to access the present invention to cause the data to be delivered within the data stream of digital television stations (or other appropriate bandwidth “inventory” that has been posted for sale). Such data would not be intended for reception by the general public, and may be encrypted or transmitted in a format that would not normally be useful to the general public. Alternatively, a large enterprise may wish to schedule the broadcast of a training video in certain cities at a set time. This video may also be encrypted and otherwise inaccessible to the general public. A delivery commitment input source optimized for such deliveries might be narrowly restricted or even freely available to all viewers through a web site or other publicly assessable computer/user interface. Such a site would allow the user to specify the requisite criteria, such as time or time range of delivery, geographic areas in which delivery is to be fulfilled, the URL or other address of the source of the data to be delivered, and other parameters. The present invention may or may not generate switch or other commands to facilitate delivery of the data according to the commitment;

(4) switch or other commands; Although in preferred embodiments switch commands are generally used to facilitate the fulfillment of delivery commitments, such commands may be used independently of delivery commitments. One aspect of the present invention is to cause receiving device 58 to change input sources (effectively, to “change channels”) or perform other operations (e.g., store, transfer, or display other content, or execute computer programs). An example of a delivery commitment input source that is optimized for the delivery of commands only (as opposed to commands associated with certain data delivered in conjunction with the command) is a web interface, for example, that allows the user to control the core functions of receiving device 58 to the full extent such device is responsive to commands delivered across a telecommunications network. An end user may wish to command his or her receiving device 58 to receive and display, or record for later use, a particular video program or other multimedia content, either instantaneously or at a later time. For example, an office worker may learn through casual conversation that a documentary of particular interest is to be broadcast that evening. The office worker may log into a secure web site and enter a command that would be delivered via the system of the present invention, and which would cause his or her personal receiving device 58, at the designated time, to “change channels” and output for display the designated program channel. Or, the user may access the web interface to command his or her device to record the program for later playback, or (if the user is watching television at the proscribed time) to display a menu or dialog box reminding the user of the program and offer to display it;

(5) other classes of content or data to be delivered.

Regardless of the delivery commitment input source used, the present invention may treat commitments for the delivery of commands, data, and programming similarly. An administrator of the present invention may establish levels of access and set priorities for the use of available bandwidth and other inventory. For example, the administrator may establish a priority scale that establishes the following general levels of priority: 1) broadcast programming intended for reception by the general public regarding matters of public safety; 2) narrowband commands or messages that require few system resources but which are latency sensitive; 3) advertising or other deliveries that are needed for imminently expiring commitments; 4) advertising or other data that is latency insensitive.

Particular users or classes of users may be assigned different levels of access to the present invention for the input of delivery commitments and commands, and each user or class of user may be given the capability to override or otherwise modify the general levels of priority. For example, a participating DTV station might have the right to override system-wide priorities as to all programming or content actually delivered by that DTV station. Users may be given ultimate control over the execution of commands by their own receiving devices. Media buyers wishing to achieve a higher level of assurance that their advertisements will air under particular conditions may pay a higher fee to achieve that result.

The present invention also provides a method for the synchronization of the transmission and delivery of data and commands across two or more communications networks such that, upon execution of certain commands, receiving device 58 may output a seamless stream of video, audio, and/or other data that has been compiled or concatenated from a plurality of sources.

While the present invention has been described in terms of preferred and example embodiments, other embodiments and variations are within the scope of the following claims.

What is claimed is:

1. A method for creating a virtual media channel at an end user, comprising:
receiving a first signal including national programming;
receiving a second signal including local programming;
receiving a network command originating from somewhere other than the end user; and
switching between said first and second signals in response to said network command, wherein said switching occurs at the end user.

2. The method of claim 1, further comprising:
receiving a second network command; and
switching back between said first and second signals in response to said second network command.

3. The method of claim 1, wherein said receiving a first signal comprises receiving a satellite signal including national programming.

4. The method of claim 1, wherein said receiving a first signal comprises receiving a direct broadcast satellite signal including national programming.

5. The method of claim 1, wherein said receiving a first signal comprises receiving a cable signal including national programming.

6. The method of claim 1, wherein said receiving a second signal comprises receiving a broadcast television signal including local programming.

7. The method of claim 1, wherein said receiving a second signal comprises receiving a digital broadcast television signal including local programming.

8. The method of claim 1, wherein said receiving a second signal comprises receiving a cable signal including local programming.

9. The method of claim 1, further comprising storing said second signal at the end user.

10. The method of claim 9, wherein said switching between said first and second signals comprises switching between said first signal and said stored second signal in response to said network command.

11. The method of claim 1, further comprising storing said network command at the end user.

12. The method of claim 1, wherein said receiving a network command comprises receiving a network command including a time to switch between said first and second signals.

13. The method of claim 11, wherein said receiving a network command comprises receiving a network command including a time to switch between said first and second signals.

14. The method of claim 13, wherein said switching between said first signal and said second signal comprises switching between said first signal and said second signal at said time to switch included in said network command.

15. The method of claim 14, further comprising storing said second signal at the end user.

16. The method of claim 14, wherein said switching between said first signal and said second signal at said time to switch comprises switching between said first signal and said stored second signal at said time to switch.

17. A method for creating a virtual media channel at an end user, comprising:
receiving a first signal including a first program stream;
receiving a second signal including a second program stream;
receiving a command originating from somewhere other than the end user; and
switching between said first and second signals in response to said command, wherein said switching occurs at the end user.

18. The method of claim 17, wherein said receiving a first signal comprises receiving a first signal including a national program stream.

19. The method of claim 18, wherein said receiving a second signal comprises receiving a second signal including a data stream.

20. The method of claim 18, wherein said receiving a second signal comprises receiving a second signal including a national program stream.

21. The method of claim 18, wherein said receiving a second signal comprises receiving a second signal including a local program stream.

22. The method of claim 17, wherein said receiving a first signal comprises receiving a satellite signal including a first program stream.

23. The method of claim 17, wherein said receiving a first signal comprises receiving a cable signal including a first program stream.

24. The method of claim 17, wherein said receiving a first signal comprises receiving a broadcast television signal including a first program stream.

25. The method of claim 17, wherein said receiving a first signal comprises receiving a digital broadcast television signal including a first program stream.

26. The method of claim 25, wherein said receiving a digital broadcast television signal comprises receiving a digital broadcast television signal including a data stream.

27. The method of claim 17, wherein said receiving a first signal comprises receiving a first signal including a local program stream.

28. The method of claim 27, wherein said receiving a second signal comprises receiving a second signal including a local program stream.

29. The method of claim 27, wherein said receiving a second signal comprises receiving a second signal including a data stream.

30. A receiving device located at an end user comprising:
a first receiver channel that receives a first signal including a first data stream;
a second receiver channel that receives a second signal including a second data stream;
a third receiver channel that receives a third signal including a network command originating from somewhere other than the end user; and
a switch that switches between said first receiver channel and said second receiver channel based on said network command.

31. The receiving device of claim 30, further comprising a storage device.

32. The receiving device of claim 31, wherein said storing device stores said first data stream.

33. The receiving device of claim 31, wherein said storing device stores said network command.

34. The receiving device of claim 30, wherein said first receiver channel comprises a direct broadcast satellite receiver channel.

35. The receiving device of claim 30, wherein said first receiver channel comprises a broadcast television receiver channel.

36. The receiving device of claim 30, wherein said first receiver channel comprises a digital broadcast television receiver channel.

37. The receiving device of claim 30, wherein said first receiver channel comprises a cable receiver channel.

38. The receiving device of claim 34, wherein said second receiver channel comprises a broadcast television receiver channel.

39. The receiving device of claim 38, wherein said second receiver channel comprises a digital broadcast television receiver channel.

40. The receiving device of claim 31, wherein said switch switches between said first receiver channel and said storage device based on said network command.

41. The receiving device of claim 30, wherein said second receiver channel and said third receiver channel are the same.

42. The receiving device of claim 31, wherein said first receiver channel comprises a telecommunications channel.

43. The receiving device of claim 42 wherein said first data stream is received on said telecommunications channel and cached on said storage device.

44. A receiving device comprising:
a first receiver that receives a first data stream from a direct broadcast satellite system;
a second receiver that receives a second data stream from a broadcast television system; and
a switch connected to said first receiver and said second receiver and responsive to a network command.

45. The receiving device of claim 44 wherein said second data stream includes local programming.

46. The receiving device of claim 44 wherein said second data stream includes data files.

47. The receiving device of claim 44 further comprising a storage device said second data stream.

48. A switch comprising:
a first input connected to a first receiver;
a second input connect to a second receiver; and
an output for providing one of said first input and said second input device to an output device,
wherein said switch switches between said first input and said second output in response to a remotely originated command.

49. A method for creating a virtual media channel, comprising:
monitoring a first signal for cue data, wherein said first signal includes national programming;
generating an avail profile using said cue data;
selecting a delivery commitment that can be satisfied by said avail profile, wherein local program content is associated with said delivery commitment;
transmitting a second signal with said local program content according to said avail profile; and
causing a receiving device located at or near the point of reception by an end user to switch between said first signal and said second signal.

50. The method of claim 49, wherein said causing a receiving device to switch between said first signal and said second signal comprises sending a switch command.

51. The method of claim 50, wherein said sending a switch command comprises broadcasting a switch command.

52. The method of claim 51, wherein said broadcasting a switch command comprises broadcasting a switch command over a direct broadcast satellite signal.

53. The method of claim 51, wherein said broadcasting a switch command comprises broadcasting a switch command over a broadcast television signal.

54. The method of claim 50, wherein said sending a switch command comprises sending a switch command over a cable network.

55. The method of claim 50, wherein said sending a switch command comprises sending a switch command over a telecommunications network.

56. The method of claim 49, wherein said transmitting a second signal with said local program content comprises transmitting a second signal with advertising content.

57. The method of claim 49, wherein said transmitting a second signal with said local program content comprises transmitting a second signal with data delivery content.

58. A method for providing a local program stream to an end user receiving a national program stream:
monitoring said national program stream for indicia regarding a local program segment;
transmitting said local program stream during said local program segment;
causing an end user receiving device to switch between said national program stream and said local program stream at the start of said local program segment.

59. The method of claim 1, wherein receiving the network command includes linking to a public switched telephone network.

60. The method of claim 1, wherein receiving the network command includes linking to a Web-based interface.

61. The method of claim 1, wherein receiving the network command includes linking to the Internet.

62. The method of claim 1, wherein receiving the network command includes linking to a telecommunications network.

63. The method of claim 17, wherein receiving the command includes linking to a public switched telephone network.

64. The method of claim 17, wherein receiving the command includes linking to a Web-based interface.

65. The method of claim 17, wherein receiving the command includes linking to the Internet.

66. The method of claim 17, wherein receiving the command includes linking to a telecommunications network.

67. The receiving device of claim 30, wherein the third receiver channel includes an interface to a public switched telephone network.

68. The receiving device of claim 30, wherein the third receiver channel includes an interface to a Web-based user interface.

69. The receiving device of claim 30, wherein the third receiver channel includes an interface to the Internet.

70. The receiving device of claim 30, wherein the third receiver channel includes an interface to a telecommunications network.
